(19) United States
(12) Patent Application Publication
(10) Pub. No.: US 2012/0194914 A1
(43) Pub. Date: Aug. 2, 2012

(54) DIFFUSING DEVICE FOR DIFFUSING LIGHT, AND SAFETY-GLASS PANEL, LIGHT SOURCE AND GREEN-HOUSE COMPRISING DIFFUSING DEVICE

(76) Inventor: Petrus Antonius Van Nijnatten, Deurne (NL)

(21) Appl. No.: 13/145,426

(22) PCT Filed: Jan. 20, 2010
(86) PCT No.: PCT/EP2010/050638

§ 371 Date: Oct. 4, 2011

(30) Foreign Application Priority Data
Jan. 20, 2009 (NL) N2002432

(51) Int. Cl. G02B 5/02

(52) U.S. Cl. 359/599

(57) ABSTRACT

The invention relates to a diffusing device (10, 12, 14), to a safety-glass panel (100, 110), to a light source (200) and to a greenhouse (300). The diffusing device according to the invention comprises a first surface (20) and a second surface (22) arranged opposite the first surface. Each one of the first surface and the second surface constitutes a border between two transmissive media which have different refractive indexes (n₁, n₂). Each one of the first surface and the second surface further comprise a substantially continuous wave pattern (30, 32) constituted of protrusions (40) from the first surface and from the second surface and of indentations (42) in the first surface and in the second surface for diffusing impinging light via refraction. The wave pattern (30, 32) comprises a relatively smooth pattern (30, 32).

### FIELD OF THE INVENTION

The invention relates to a diffusing device for diffusing light impinging on the diffusing device.

The invention further relates to a safety-glass panel, to a light source and to a greenhouse comprising the diffusing device.

### BACKGROUND OF THE INVENTION

Diffusing devices for spreading impinging light are known. They are used in various applications ranging from relatively small diffusers for spreading light of light sources to improve a uniformity of the emitted light, to relatively large glass screens which may be used to, for example, transmit light or sunlight into a room without being able to see details inside the room through the glass screen. Diffusing devices are also used in, for example, roof-panels in greenhouse for diffusing the light entering the greenhouse. These diffusing devices often are constituted of a glass-panel comprising white paint to diffuse the impinging sunlight. According to Hemming, Mohammadkhani and Dueck (Diffuse greenhouse covering materials material technology, measurements and evaluation of optical properties, Acta Horticulturae 797 (2008) p. 469-476), at high irradiation levels diffuse greenhouse coverings result in better light distribution, lower crop temperature, decreased transpiration, and increased photosynthesis and growth, despite the fact that these coverings generally have lower light transmission compared to clear transparent greenhouse coverings.

So the main performance parameters for greenhouse coverings are transmittance and haze. Haze is defined as the fraction of the light transmitted by a substrate, that is scattered or refracted in directions deviating from the direction of the incident light. More haze means that a smaller fraction of the transmitted light propagates substantially parallel to the incident light and thus more light is being spread. The optimal greenhouse covering should therefore have a relatively high haze value in combination with a relatively high transmissivity.

Optical sheets for spreading light are well known, for example from the U.S. Pat. Nos. 6,798,574 and 6,456,437. In these optical sheets prism diffusers are applied for spreading the light via diffraction of the light.

A drawback of these known systems is that the efficiency of the transmission is limited.

Published US patent application US200910013992 discloses a translucent sheet of which the cross-sectional view of the sheet has a zigzag profiled surface structure on either side of the sheet. The zigzag profile is used to trap as much solar radiation as possible. According to the cited document, the corners of the zigzag profile have to be as sharp as possible to obtain the largest effective surface area of the sheet for trapping of solar radiation. However, the sharp corners of the zigzag pattern generate uncontrollable scattering of light and which leads to considerable light losses.

Published European patent application EP2128520 discloses a lighting apparatus comprising of a LED light source and a first and second light diffusion member. The light from the LED is successively transmitted through the first and the second light diffusion member to suppress the divergence of lighting apparatus. The first and the second diffusion member are film-type transparent sheets with at least one surface of linear U-shaped ridges. The point lines along which two neighbouring U-shaped ridges meet each other form a sharp line in the surface of the sheet. The sharp line generates uncontrollable scattering of light and which leads to considerable light losses.

### SUMMARY OF THE INVENTION

It is an object of the invention to provide a diffusing device having improved transmission efficiency.

According to a first aspect of the invention the object is achieved with a diffusing device for diffusing light impinging on the diffusing device of claim 1. According to a second aspect of the invention, the object is achieved with a safety-glass panel of claim 11. According to a third aspect of the invention, the object is achieved with a light source of claim 12. According to a fourth aspect of the invention, the object is achieved with a greenhouse of claim 13.

According to the first aspect of the invention, the diffusing device comprises a first surface and a second surface arranged opposite the first surface, each one of the first surface and the second surface constituting a border between two transmissive media having different refractive indexes and each one of the first surface and the second surface comprising a substantially continuous wave pattern constituted of protrusions from the first surface and from the second surface and indentations in the first surface and in the second surface for diffusing the impinging light via refraction. The wave pattern comprises a relatively smooth pattern.

Within the context of this text, substantially continuous wave pattern means a wave pattern which spreads across the whole usable part of the surface of the diffusing device. The usable part of the surface typically is that part of the surface through which light transits through the diffusing device. When, for example, the wave pattern is applied to a light input window of the diffusing device, the wave pattern extends over the whole light input window. When, for example, the wave pattern is applied to a light output window of the diffusing device, the wave patter extends over the whole light output window.

An effect of the diffusing device according to the invention is that the use of a refractive pattern applied on both the first and second surface enables an efficient diffusing of the impinging light while having relatively high efficiency. When light impinges on the first surface, the protrusions and indentations in the wave pattern act as small lenses redirecting the impinging light beams and as such spreading the light beams over a relatively large area. The inventor has found that due to the presence of the second surface also having the wave pattern for refracting light, reflection of light refracted by the first surface from the second surface is reduced, thus improving the overall efficiency. Part of the light refracted by the first surface at relatively large angles from a normal axis of the first surface, for example, at 40 degrees which is close to the critical angle in glass, would reflect from a substantially planar second surface and thus reduce the efficiency. Here the normal axis of the first surface is an axis arranged perpendicular to an average of the first surface and not an axis perpendicular to the local structure of the wave pattern at the first surface. Due to the wave pattern at the second surface, the reflection losses at the second surface are substantially reduced, especially for light refracted from the first surface at relatively large angles from the normal axis, thus improving the efficiency of the transmission of the diffusing device. The diffusing device may, for example, comprise a substrate constituted of transmissive material in which one side of the substrate constitutes the first surface being a border between air and the substrate. The opposite side of the substrate constitutes, for example, the second surface being a border between the substrate and air. In such configuration the overall transmission efficiency of the diffusing device is higher compared to a similar substrate without the wave pattern for all angles of incidence of the impinging light. In addition, the spreading as a result of the refraction from the wave pattern is enhanced as the diffusing device comprises two consecutive surfaces which each spread the light. So next to a highly efficient transmission due to the dual wave pattern, the diffusion efficiency of the diffusing device is also relatively high.

In contrast, using a diffractive pattern which is only applied to a single surface of a diffuser as shown in the known diffuser of U.S. Pat. No. 6,798,574 the diffracted light has to traverse a substantially planar surface which results in relatively high reflection losses, especially when the angles of diffraction of the diffracted light are relatively high. Furthermore, diffractive pattern often has relatively sharp edges which act as light scattering centers and which redirect the light in a substantially uncontrolled manner which typically also cause much light to be lost. Finally, diffractive structures typically have dimensions near the wavelength dimension of at least part of the impinging light and may cause separation of color which is also not preferred in light diffusing devices which are used, for example, to improve the spreading of light in a room or in, for example, a greenhouse.

So the wave pattern refracts the light to diffuse the light and as such comprises a relatively smooth pattern having dimensions at least two orders of magnitude larger than the wavelength of the light which is refracted from the wave pattern.

The wave pattern comprises a relatively smooth pattern. Relative smooth that a function representing the wave pattern may at least be differentiated once and the resulting first derivate function is continuous. Relative smooth may also relate to a smooth function which may be differentiated more than once.

As indicated before, sharp edges may cause scattering of the impinging light at the edges which may generate uncontrollable scattering of light and which may lead to considerable light losses and thus reduce the efficiency of the diffusing device. As such, also a pattern resembling a Fresnel-lens should be avoided as typically half of the protrusion or indentation forming the Fresnel-lens is a straight edge and the transition from the curved part to the straight part typically comprises sharp edges generating scattered light increasing the losses in the system. So a relatively smooth pattern is preferred in which, for example, each protrusion and indentation may be a symmetrical protrusion and indentation. However, also shapes deviating from the perfectly symmetric wave patterns may be used for diffusing and redirecting the transmitted light as long as the pattern is free from sharp edges. So in the context of the current invention, a wave pattern not only comprises a perfect or near perfect sine-wave pattern, but also comprises any other wave-like pattern free from sharp edges. So the dimensions of the protrusions may be different from the dimensions of the indentations.

A further benefit of the smooth wave pattern is that it may be relatively easy to etch into, for example, a substrate using a relatively rough etching process. To generate abrupt patterns using etching requires tight etch processing control, which is, for example, used in semiconducting industry to generate sharp line and space structures. However, in this case, a smooth wavy pattern is required in which abrupt pattern variations should be avoided. Thus, a relatively rough etching process may suffice to generate the diffusing device. Furthermore, such etching process may also improve the quality of the substrate, especially when the substrate is constituted of glass material. When etching the wave pattern, the etching process removes surface cracks in the glass substrate. Surface cracks in glass substrates limit the strength of the glass and may grow due to environmental influences such as relatively large temperature difference. When etching the surfaces of the glass substrate, the surface cracks are reduced or even removed, thus improving the strength of the glass substrate.

Finally, a smooth wave pattern has a benefit in that it is easier to clean, especially when applying the diffusing device in a greenhouse, for example, as roof-panel of the greenhouse. Due to the relatively high humidity in a greenhouse, roof-panels may require cleaning of algae which thrive in humid environments and which may obstruct sunlight. Algae adhere relatively easily to relatively rough surfaces. By having the smooth wave pattern, the algae have difficulty clinging to the first or second surface and thus may be removed relatively easily.

In an embodiment of the diffusing device, lines representing protrusions in the wave pattern of the first surface are arranged substantially parallel to further lines representing protrusions in the wave pattern of the second surface for generating a predetermined distribution of diffusely transmitted light. A benefit of this embodiment is that the parallel arrangement of the lines and the further lines allows actively influencing the distribution of the light diffused and transmitted by the diffusing device. When arranging the lines and further lines substantially parallel to each other, the wave pattern of the first surface refracts the impinging light especially in a direction perpendicular to the lines representing the protrusions. In this way, the wave pattern of the first surface already alters the distribution of the impinging light and spreads the light more in a direction perpendicular to the lines compared to the direction parallel to the lines. The presence of the second surface having the wave pattern in which the further lines are arranged parallel to the lines of the first surface, the wave pattern of the second surface not only reduces the reflection of the refracted light from the second surface, but also increases the spreading of the light in the direction perpendicular to the lines or further lines and as such increases the difference in spreading of diffuse light in the direction perpendicular to the lines or further lines compared to the direction parallel to the lines or further lines. When, for example, the diffusing device according to the current embodiment is used as roof-panel in a greenhouse in which the lines and further lines are arranged in a north-south direction, the presence of the diffusing device generates diffuse light with a high transmissive efficiency of the diffusing device. Furthermore, the arrangement of the lines and further lines spread the impinging light more in the east-west direction than in the north-south direction. A result of this diffusing device as roof-panel is that it evenly spreads the impinging light of the sun across the greenhouse during the day and as such reduce the overall light intensity differences in the greenhouse during the day.

In an embodiment of the diffusing device, the wave pattern is configured for generating a predetermined distribution of the diffusely transmitted light, the lines representing protrusions comprise a pattern and/or comprise a curved shape for generating the predetermined distribution. The lines may not necessarily be straight lines, but may be curved, for example, around a light emitter. Because the asymmetric distribution of the diffusely transmitted light is substantially in a direction perpendicular to the lines, curved lines may be used to enhance light intensity in specific directions and as such may be used to generate substantially any predetermined light distribution required. When the diffusing device is, for example, used to spread the light originating from a light emitting diode, the transmitted light is made diffuse at relatively high efficiency, as indicated before, but by adapting the wave pattern such that the lines representing protrusions in the wave pattern are shaped in, for example, circles, the spreading of the diffusely transmitted light is away from the optical axis of the light emitting diode when the center of the circles is at the optical axis. Choosing other shapes, other directional distributions of the diffusely transmitted light may be generated at wish. Again, preferably the lines and further lines are arranged parallel, so the further lines mimic the pattern of the lines to further enhance the directional efficiency of the applied pattern.

This diffusing device may be very beneficial when using light emitting diodes as light sources in greenhouses. As is well known, the energy efficiency of light emitting diodes is superior to other light sources, and as such they should be the preferred light source in greenhouses. However, due to the relatively strong directivity of the generated radiation from light emitting diodes, either many spatially distributed light emitting diodes are required to cover all plants in the greenhouse or relatively large light intensity variations must be tolerated. The location of illumination units in greenhouses should preferably be limited to just below the gutter of the greenhouse to limit the obstruction of sunlight into the greenhouse. When using the diffusing device according to the present embodiment of the invention for diffusing the light emitted by the light emitting diode, the spreading of the light may be enhanced by the appropriate wave pattern which may even be enhanced in specific directions such that substantially the same amount of light reaches substantially all plants in the greenhouse while the number of light sources is limited, for example, to at or near the gutters of the greenhouse.

In an embodiment of the diffusing device, when there is a further surface present between the first surface and the second surface, the further surface being a non-planar surface. As has been explained above, having a planar surface in the diffusing device results in reflection losses and reduces the transmission efficiency of the diffusing device. In the context of the current invention, a planar surface is a surface which still may have surface height variations and in which a ratio between an amplitude (further indicated with A) of the height variation and a pitch (further indicated with P) of the height variation is less than 5%: A/P<0.05. The amplitude is defined as the distance between the height of the protrusion and the depth of the indentation. So a surface having curved structures forming protrusions or indentations in which A/P<0.05 still is considered to be a substantially planar surface. The reason for this definition is that such structures still have relatively high reflectivity at oblique incidence which should be avoided in the diffusing device according to the invention to maintain a relatively high transmission efficiency of the impinging light.

In the context of the current invention, the further surface also constitutes a border between two transmissive media having different refractive indexes. If the refractive indexes of the two media would be substantially equal, the further surface would optically not make a difference to the redirection of the impinging light and would thus be regarded as not being present in the embodiment. This may be the case when, for example, two substrates are attached via a glue or plastic foil which the refractive index of the glue and/or foil substantially correspond to the refractive index of the substrates which are attached. In such a case, the shape of the further surface is of no influence to the diffusing of the transmitted light and as such optically makes no difference. So also the further surface in the diffusing device according to the current embodiment must be a surface constituting a border between two transmissive media having different refractive indexes.

In an embodiment of the diffusing device, a pitch between two successive protrusions in the wave pattern in a direction substantially parallel to the surface is within a range between 0.05 millimeter and 10 millimeter. In this context, substantially parallel means that the direction is along the direction of the average surface and not along the direction of the surface at the specific location in the wave pattern. A benefit of a wave pattern having a pitch within the defined range is that it may still be relatively simple produced using, for example, contact-printing techniques in combination with relatively rough etching processes. This ensures that the diffusing device may be produced relatively cost effective and thus that it may be possible to apply the diffusing device in relatively large area, for example, as a roof-panel in a greenhouse. A lower limit of 0.05 millimeter is determined by the preferred production process being a relatively rough etching process, and by the fact that the wave pattern should not result in a diffraction grating as explained earlier. The upper limit of 10 millimeter is determined by the diffusion efficiency and the reflectivity of the surface. When the pitch becomes too large, the slope of the wave pattern remains relatively small causing the wave pattern at the surface to still reflect a considerable amount of impinging light, reducing the efficiency of the diffusing device. The optimum pitch of the wave pattern in a particular diffusing device depends for a given amplitude on the required level of spreading of transmitted light by the diffusing device and may vary for different applications.

In an embodiment of the diffusing device, an amplitude between a protrusion and an adjacent indentation in the wave pattern in a direction perpendicular to the surface is within a range between 0.01 millimeter and 2 millimeter. A lower limit of 0.01 millimeter is defined to still achieve effective refraction of the impinging light to diffuse the impinging light. The upper limit is determined by the fact that when the first surface and second surface are at opposite sides of a single substrate, the thickness of the substrate is not reduced too much by the wave pattern such that the strength of the substrate is reduced. To still achieve sufficient diffusing of light, the wave pattern of the current invention is preferably shaped such that the ratio between the amplitude (A) and the pitch (P) is equal or larger than 5%: A/P≧5%. As mentioned before, when this ratio is smaller than 5%, the surface is considered to be substantially planar as the reflection losses still are too large and the diffusing characteristics are typically insufficient.

In an embodiment of the diffusing device, the first surface is a light input surface of the diffusing device and the second surface is a light output surface of the diffusing device.

In an embodiment of the diffusing device, the diffusing device comprises a substrate comprising both the first surface on one side of the substrate and the second surface on an opposite side of the substrate. As mentioned before, this embodiment results in a relatively simple and cheap diffusing device which enables to redirect the light distribution in a relatively simple manner and which enables to be produced relatively cheap: the diffusing device may be constituted of a substrate of glass material or of transmissive plastics material in which the wave pattern, for example, is generated via contact print together with etching on both sides of the substrate. Due to the relative simple production process, the diffusing device according to the current embodiment may cost-effectively be used as roof-panel in greenhouses improving the distribution of the light in the greenhouse for the impinging sunlight.

In an embodiment of the diffusing device, the diffusing device comprises the substrate and a further substrate substantially identical to the substrate and wherein the substrate and further substrate are configured for generating a translucent safety-glass panel. The wave pattern in the first and second surface of the substrate may differ and the wave patterns of the substrate may differ from the wave patterns in the first and second surface of the further substrate without departing from the scope of the invention. The safety-glass panel generally has two translucent plates arranged parallel to each other and connected together, preferably having a translucent or transparent foil between the two substrates for connecting the two substrates. This translucent or transparent foil may be a plastic translucent or transparent foil configured for gluing the first substrate to the further substrate. Furthermore, this translucent foil generally has the ability to keep the safety-glass panel together when one or both of the substrates break. Especially when using the safety-glass panel as roof-panel in a greenhouse, this roof-panel should preferably be made of safety-glass such that when some of the roof-panels break, people inside the greenhouse may not be injured.

According to the second aspect of the invention, the object is achieved with a safety-glass panel comprising the diffusing device according to the invention. This embodiment also includes the fact that only one of the two substrates in the safety-glass panel constitutes the diffusing device rather than using two substantially identical substrates as mentioned before. Although not an optimal solution, the combination of a substrate being the diffusing device in combination with a planar substrate to form the safety-glass panel may already improve the diffusing of the light and may already create a non-symmetric distribution of the transmitted light while the overall cost of this safety-glass panel is less compared to the safety-glass panel where both substrates each comprise the first surface and second surface.

According to the third aspect of the invention, the object is achieved with a light source comprising a light emitter and the diffusing device according to the invention for diffusing the light emitted by the light emitter. The light emitter is preferably a light emitting diode which emits a relatively narrow bundle of light. The diffusing device is used to spread the light emitted from the light emitting diode. Especially when using such light emitting diodes in, for example, a greenhouse, the spreading of the light to reach all plants in need of light in the greenhouse is important for the quality of the harvest from the plants. Using the diffusing device according to the invention enables not only to have a very efficient diffusing element to spread the light emitted by the light emitting diode, but also enables to adapt the spreading of the light such that substantially all plants or possible plant locations in the greenhouse receive the required amount of light. As mentioned before, the locations preferred for illumination systems in greenhouses is the gutter of the greenhouse. Having to add more locations to reach all plants in the greenhouse requires an increase in the complexity of the infrastructure of the greenhouse to also provide power at these additional locations. Furthermore, the additional light sources would obstruct sunlight. The use of the diffusing device enables the use of light emitting diodes only below the gutter in the greenhouse, while still spreading the sufficiently to reach all plants in need of light.

According to the fourth aspect of the invention, the object is achieved with a greenhouse comprising the diffusing device according to the invention or comprising the safety-glass panel according to the invention. As mentioned before, the use of the diffusing device enables a substantially even illumination of the plants in the greenhouse. For some plants, for example, pepper-plants, it seems that relatively large variations of light intensity during the day is not preferred. Providing an average illumination level throughout the day seems to enhance the growth of fruits from the pepper-plants and as such improves the harvest from the pepper-plants. Having the diffusing device according to the invention as roof-panel on the greenhouse enables to spread the impinging sunlight which reduces the variation of the light at any location inside the greenhouse during the transit of the sun. This spreading of the sunlight in the east-west direction causes the light to be spread throughout the greenhouse and reduces shady places in the greenhouse. Furthermore, the spreading causes the illumination level at any time of the day to be closer to the average illumination level and as such reduce light variations during the day.

In an embodiment of the greenhouse, the greenhouse comprises the diffusing device or the safety-glass panel as roof-panel, the lines representing protrusions in the wave pattern of the first surface and/or the second surface being arranged, in use, in a north-south orientation. By arranging the lines representing protrusions in the wave pattern of the first surface in the north-south orientation, the asymmetrical light distribution spreads the light more in the east-west orientation compared to the north-south orientation. As the spreading of light is increased substantially parallel to the path of the sun, the light is spread along the path of the sun during the day and as such averaging out the light intensity inside the greenhouse continuously throughout the day, levelling the illumination level throughout the day reducing intensity variations during the day. Preferably the further lines representing the protrusions in the wave pattern of the second surface are parallel to the lines representing protrusions in the wave pattern of the first surface, as this enhances the redirection of the diffused transmitted light and thus provides an optimal spreading of the diffused light in the east-west direction to optimise the averaging of the light inside the greenhouse.

In an embodiment in which the greenhouse is not positioned parallel to the north-south axis, the lines on the roof-panel may be adapted such that in use the lines representing protrusions in the wave patter still are arranged in the north-south orientation. As such, any misalignment of the greenhouse may be corrected by the wave pattern on the roof-panel to still obtain an optimum light spreading inside the greenhouse during the day with minimal light intensity variations during the day.

In an embodiment of the greenhouse, the lines representing protrusions in the wave pattern of the first surface and/or the second surface are arranged, in use, substantially parallel to a roof-ridge and/or a gutter of the greenhouse. This results in an optimal spreading of the impinging sunlight when the greenhouse is arranged with the roof-ridge substantially parallel to the north-south axis.

In an embodiment of the greenhouse, the crops are growing in the greenhouse in substantially parallel arranged rows of plants. The lines which represent the protrusions in the wave pattern of the first surface and/or of the second surface are arranged, in use, substantially perpendicular to the rows of plants. Between the rows of plants there is a space which is used by people and/or equipment, for example, to look after and to harvest the crops. Further, the spaces between the rows of plants have an important function with respect to the transmission of light to the lower parts of the crops. For example, tomato plants typically reach 1 to 3 meter in height, and the leaves and the tomatoes grow over the full height of the tomato plant. The leaves and the tomatoes at the lower parts of the crops have to receive light as well. If the lines representing the protrusions are arranged substantially perpendicular to the rows of plants, the impinging light is more spread in the direction which is substantially equal to the rows of plants than in the direction of the lines presenting the protrusion. This is advantageous, because it allows the light to impinge the spaces between the rows of plants up to the lower parts of the plants, and prevents that only the higher parts of the plants receive the light and that the lower parts of the plants are standing in the shadow of the neighbouring rows of plants.

In an embodiment, the lines representing the protrusions are not arranged substantially parallel to the rows of plants. It is to be noted that, as soon as the lines are not arranged substantially parallel, but, for example form an angle of 30 degrees to the rows of plants, less light is blocked by the rows of plants, such that a smaller part of the crops are standing in the shadow of the neighbouring rows of plants.

### BRIEF DESCRIPTION OF THE DRAWINGS

These and other aspects of the invention are apparent from and will be elucidated with reference to the embodiments described hereinafter.

In the drawings:

FIGS. 1A and 1B show schematic cross-sectional views of a diffusing device according to the invention,

FIG. 2 shows a the wave pattern of a diffusing device according to the invention in detail,

FIG. 3A shows a schematic top view of a diffusing device according to the invention, and FIG. 3B shows schematically the light distribution resulting from the diffusing device of FIG. 3A,

FIG. 4A shows a schematic top view of a different diffusing device according to the invention, and FIG. 4B shows schematically the light distribution resulting from the diffusing device of FIG. 4A,

FIGS. 5A and 5B show schematic cross-sectional views of two different embodiments of a safety-glass panel according to the invention,

FIG. 6 shows a schematic cross-sectional view of the light source according to the invention,

FIG. 7A shows a schematic cross-sectional view of the greenhouse according to the invention, and

FIG. 7B schematically shows another embodiment of the greenhouse according to the invention.

The figures are purely diagrammatic and not drawn to scale. Particularly for clarity, some dimensions are exaggerated strongly. Similar components in the figures are denoted by the same reference numerals as much as possible.

### DETAILED DESCRIPTION OF THE EMBODIMENTS

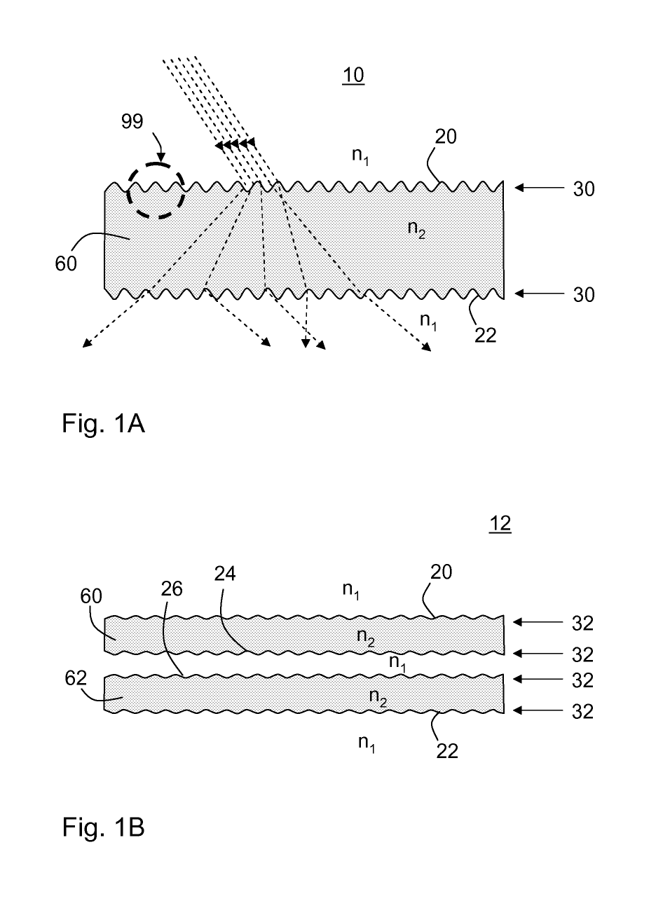

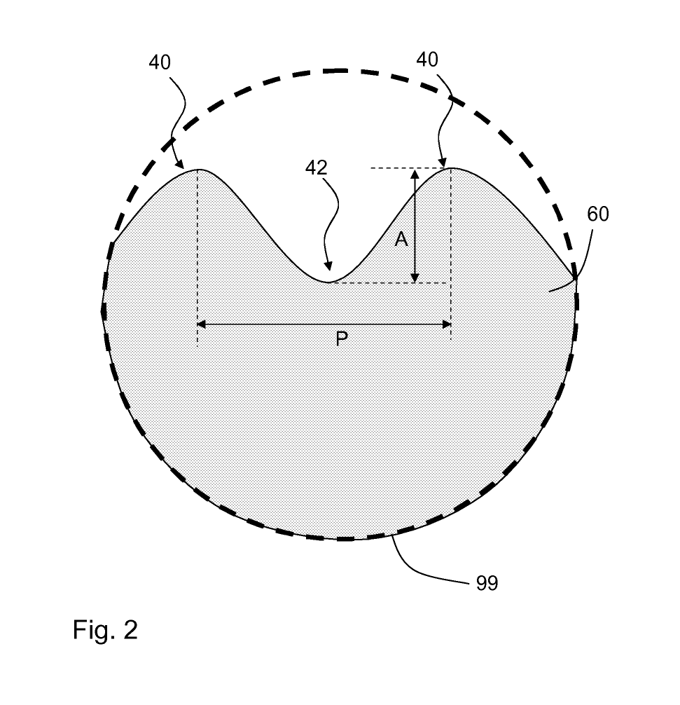

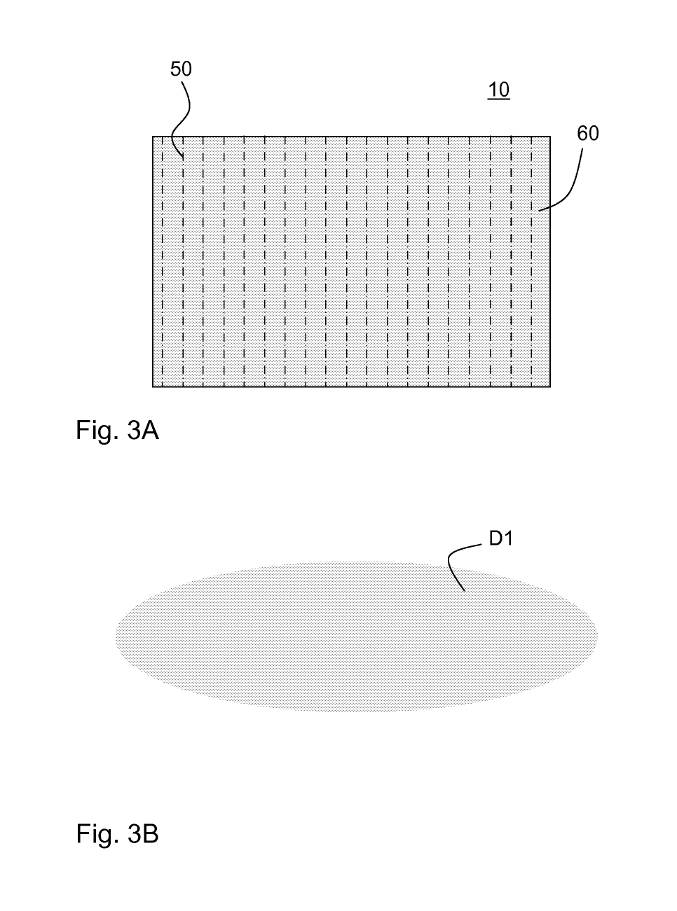

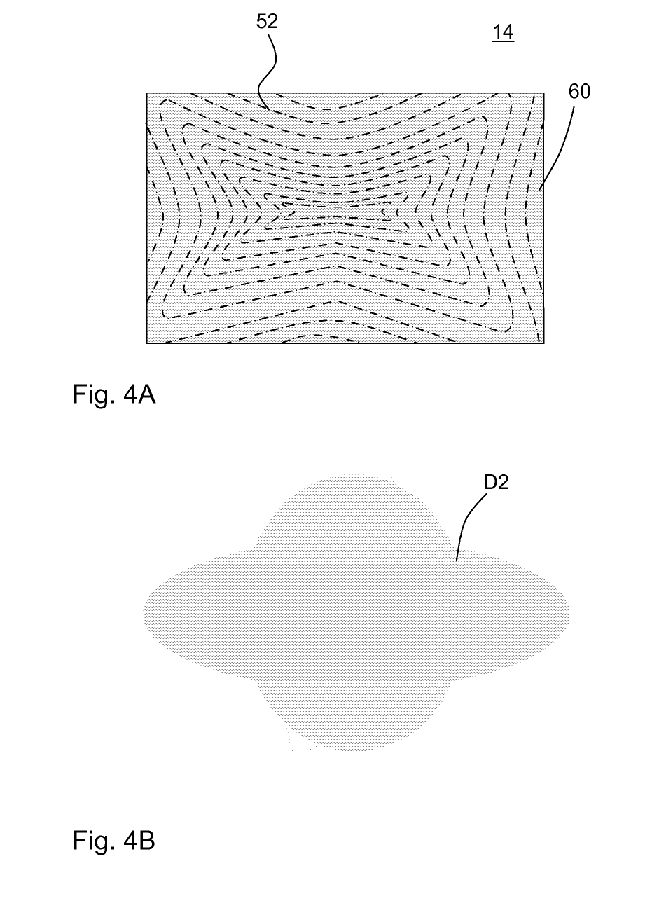

FIGS. 1A and 1B show schematic cross-sectional views of a diffusing device 10, 12, 14 (see FIG. 4A) according to the invention. The diffusing device 10, 12, 14 comprises a first surface 20 and a second surface 22 which is arranged opposite the first surface 20. Each one of the first surface 20 and the second surface 22 constitute a border between two transmissive media, for example, between air having a first refractive index n₁ and glass having a second refracting index n₂. Each one of the first surface 20 and the second surface 22 comprise a substantially continuous wave pattern 30, 32. The wave pattern 30, 32 is constituted of protrusions 40 (see FIG. 2) from the first surface 20 and from the second surface 22 and of indentations 42 (see FIG. 2) in the first surface 20 and in the second surface 22 for diffusing the impinging light via refraction. The effect of the wave pattern is that impinging light is refracted by the wave pattern 30, 32 of the first surface 20 in which protrusions 40 act as a positive cylindrical lens focussing the impinging light beam to a line located near the first surface 20 after which the focused light spreads strongly. Indentations 42 act as a negative cylindrical lens which spreads the light. Because the protrusions 40 and indentations 42 are substantially cylindrical lenses the light is refracted and spread out in a direction perpendicular to a lines 50, 52 (see FIGS. 3A and 4A) which represent a peak height of the protrusions 40 in the wave pattern 30, 32. In the direction parallel to the lines 50, 52 the impinging light is substantially not altered. The spreading is illustrated via the dashed lines in FIG. 1A in which a plurality of substantially parallel rays indicated with dashed arrows impinge on the first surface 20 and are spread in directions perpendicular to the lines 50, 52. After the spreading of the impinging light at the first surface 20, the spread out light impinges on the second surface 22 which also comprises the wave pattern 30, 32 and which subsequently also spreads the impinging light.

In the embodiments shown in FIGS. 1A and 1B the wave pattern 30, 32 of both the first surface 20 and the second surface 22 are identical. However this is not necessary and the wave pattern 30, 32 may be different depending on the diffusing requirements of the transmitted light and the directional requirements of the transmitted light. Furthermore, in the embodiments shown in FIGS. 1A and 1B the wave pattern 30, 32 in both the first surface 20 and the second surface 22 are parallel which means that the lines 50, 52 representing protrusions 40 in the wave pattern 30, 32 in the first surface 20 are parallel to the lines 50, 52 representing protrusions 40 in the wave pattern 30, 32 in the second surface 22. This clearly results in a strong redirection of the diffused light by the diffusing device 10, 12, 14 and may be used to generate a predetermined emission distribution D1, D2 (see FIGS. 3B and 4B). However, when the lines 50, 52 representing protrusions 40 in the first surface 20 are arranged, for example, perpendicular to the lines 50, 52 representing protrusions 40 in the second surface 22, the spreading of the light at the second surface 22 is in a direction perpendicular to the spreading of the light at the first surface 20 which may be used to generate a different emission distribution (not shown). The lines 50, 52 may be substantially straight lines arranged parallel to each other as is shown in FIG. 3A, or may have substantially any shape as is shown in FIG. 4A. Altering the shape of the lines 50, 52 will result in a different distribution of the transmitted diffused light.

In a first embodiment 10 of the diffusing device 10 as shown in FIG. 1A, the diffusing device 10 is constituted of a single substrate 60 which comprises the first surface 20 as light input surface 20 at one side of the substrate 60 and which comprises the second surface 22 as light output surface 22 at the opposite side of the substrate 60. The benefit of this embodiment is that it can be produced relatively easily and cost effectively as only a single sheet of glass 60 is required on which on both sides a wave pattern 30 has to be produced. This wave pattern 30 may be generated using well known etching processes in which the pattern may be generated using printing methods, for example, contact printing method, and in which the etching process may etch both the first surface 20 and the second surface 22 at the same time. In FIG. 1A a dashed circle 99 is indicated, showing what part of FIG. 1A is used as the enlarged detail in FIG. 2.

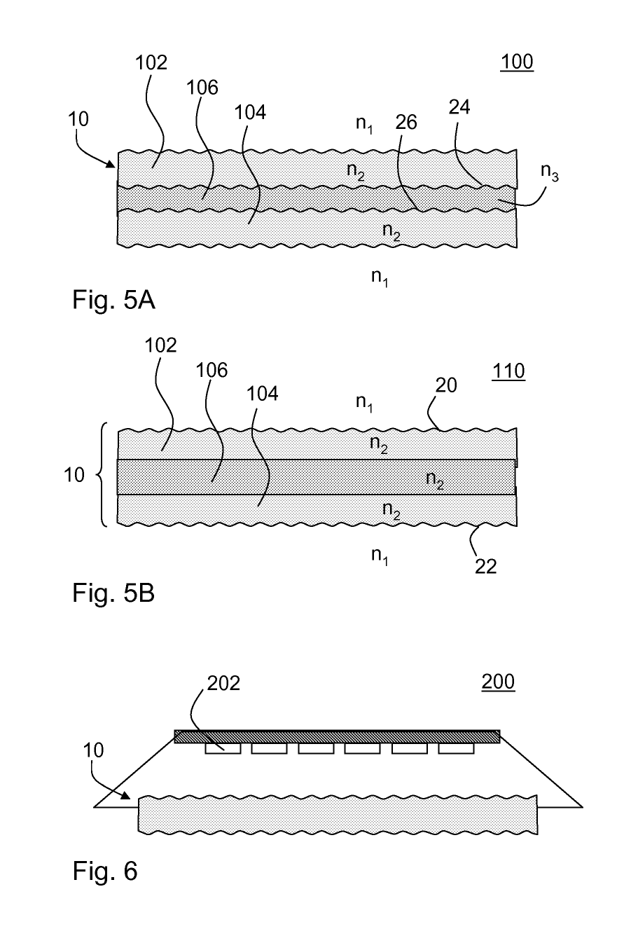

In a second embodiment 12 of the diffusing device 12 as shown in FIG. 1B, the diffusing device 12 is constituted of two substrates 60, 62 in which now each of the two substrates 60, 62 comprise two surfaces both having the wave pattern 32. Now the wave pattern 32 is altered in that the amplitude A (see FIG. 2) is reduced while the pitch P (see FIG. 2) is maintained substantially constant. As such, the diffusion angle of the refracted light is less compared to the embodiment shown in FIG. 1A. However now, more than one surface having the wave pattern 32 sequentially refract the impinging light increasing the diffusion angle at every surface. The end result may still be that a similar diffusion characteristic is achieved compared with the embodiment shown in FIG. 1B. Now, the gap between the two substrates indicated with refractive index n₁ may be used as an insulating gap resulting in an insulating glass panel. When the medium in the gap indicated with refractive index n1 indeed has a different refractive index compared to the refractive index of the two substrates 60, 62, the further surfaces indicated with 24 and 26 preferably also have a wave pattern 32 to avoid reflection losses at these further surfaces 24, 26. If the refractive index of the medium in the gap would be substantially equal to the refractive index of the two substrates 60, 62, the further surfaces 24, 26 do not optically contribute to the influencing of the impinging light and thus the shape of these further surfaces 24 26 is not important and may very well be substantially planar (see FIG. 5B).

Again, the wave pattern 32 in FIG. 1B of all surfaces 20, 22, 24, 26 of the diffusing device 12 are identical. This is, of course not required. Variations in the amplitude A, pitch P and orientation of the wave pattern 32 of the surfaces 20, 22, 24, 26 may vary to generate a required spatial spreading of the transmitted diffused light.

FIG. 2 shows a the wave pattern of a diffusing device 10 according to the invention in detail. The dashed circle 99 as shown in FIG. 1A is shown in more detail in the current FIG. 2 to clearly illustrate the protrusions 40 and indentations 42 in the wave pattern 30, 32 of the first surface 20, second surface 22 and possibly in the further surfaces 24, 46. The amplitude A is defined as the distance between the height of the protrusion 40 and the depth of the indentation 42. The pitch P is defined as the distance between the peaks of two successive protrusions 40. Alternatively, the pitch may, of course, be defined as the distance between the lowest points of two successive indentations 42. The ratio between the amplitude A and the pitch P of the wave pattern 30, 32 is preferably equal or larger than 5% to obtain sufficient refraction from the wave pattern 30, 32 to generate diffuse light, or in other words:

A/P≧0.05.

When the ratio between the amplitude A and the pitch P is less than 5%, the diffraction is not sufficient and the surface is regarded as being substantially planar. Such a substantially planar surface generates reflection losses in the diffusing device 10, 12, 14 and thus should be avoided. As indicated before, the surface which constitutes a border between two transmissive media in which the refractive index of the two media are substantially equal, does optically not contribute to the transmissive and diffusing characteristics of the diffusing device 10, 12, 14. Such a surface may have substantially any shape.

FIG. 3A shows a schematic top view of a diffusing device 10 according to the invention, and FIG. 3B shows schematically the light distribution D1 resulting from the diffusing device 10 of FIG. 3A. The schematic top view shows the lines 50 representing protrusions 40 in the wave pattern 30, 32 and show that the lines 50 at the first surface 20 and the second surface 22 are arranged substantially parallel. In FIG. 3A the lines 50 are indicated with dash-dotted lines. A bundle of light impinging on the diffusing device 10 as shown in FIG. 3A would be transmitted and diffused at a relatively high efficiency. Furthermore, the light distribution of the impinging bundle of light is elongated in the direction substantially perpendicular to the lines 50 due to the cylindrical lens characteristic of the wave pattern 30, 32 at the first surface 20 and the second surface 22. FIG. 3B shows a resulting light distribution D1 when the impinging light bundle has a substantially symmetrical circular light distribution.

FIG. 4A shows a schematic top view of a different diffusing device 14 according to the invention, and FIG. 4B shows schematically the light distribution D2 resulting from the diffusing device 14 of FIG. 4A. Again the lines 52 represent protrusions 40 in the wave pattern 30, 32 and show that the wave pattern 30, 32 may have any shape to influence the distribution of the transmitted diffused light. Also in FIG. 4A the lines 52 are indicated with dash-dotted lines. FIG. 4B shows the light distribution D2 which spreads out in a direction substantially perpendicular to the lines 52. So when a light bundle having substantially symmetrical circular light distribution (not shown) impinges on the diffusing device 14 as shown in FIG. 4A, the resulting light distribution D2 is shown in FIG. 4B. As can be seen, substantially any distribution D2 may be generated using a specific shape of the lines 52 representing the protrusions 40 in the wave pattern 30, 32.

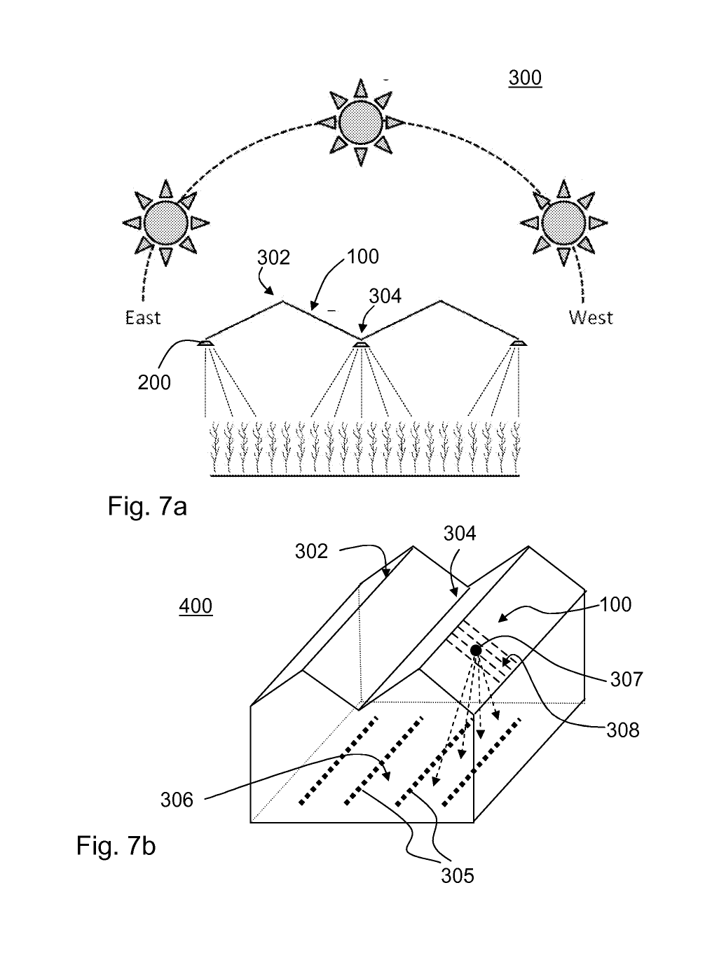

FIGS. 5A and 5B show schematic cross-sectional views of two different embodiments of a safety-glass panel 100, 110 according to the invention. The safety-glass panel 100, 110 generally has two translucent plates 102, 104 arranged parallel to each other and connected together, preferably having a translucent or transparent foil 106 or glue 106 between the two substrates 102, 104 for connecting the two substrates 102, 104. This translucent or transparent foil 106 or glue 106 may be a plastic translucent or transparent foil 106 configured for gluing the first substrate 102 to the further substrate 104. Furthermore, this translucent foil 106 or glue 106 generally has the ability to keep the safety-glass panel 100, 110 together when one or both of the substrates 102, 104 break. Especially when using the safety-glass panel 100, 110 as roof-panel 100, 110 in a greenhouse 300 (see FIG. 7), this roof-panel 100, 110 should preferably be made of safety-glass 100, 110 such that when some of the roof-panels break 100, 110, people inside the greenhouse 300 may not be injured.

The embodiment of the safety-glass panel 100 as shown in FIG. 5A, the safety-glass panel 100 comprises a translucent or transparent foil 106 or glue 106 having a different refractive index n3 compared to the refractive index of the substrates 102, 104. In such an arrangement, the surface 24 constituting a border between the first substrate 102 and the foil 106 or glue 106 and the surface 26 constituting a border between the further substrate 104 and the foil 106 or glue 106 preferably also each comprise a wave pattern 30, 32 to reduce the reflection losses. In such a configuration, the first substrate 102 may be the diffusing device 10 as shown in FIG. 1A.

In the embodiment of the safety-glass panel 110 as shown in FIG. 5B, the safety-glass panel 110 comprises a translucent or transparent foil 106 or glue 106 which has a substantially equal refractive index n2 compared to the refractive index of the substrates 102, 104. In such an embodiment, the translucent or transparent foil 106 or glue 106 is optically not visible and does not contribute to the refraction of the impinging light to obtain transmitted diffused light. So the shape of the surfaces constituting a border between the first substrate 102 and the foil 106 or glue 106 and the surface constituting a border between the further substrate 104 and the foil 106 or glue 106 may have any shape. In the current embodiment these surfaces between the first surface 20 and the second surface 22 may be planar surfaces without increasing the reflection of light and as such affecting the losses due to reflection in the safety-glass panel 110.

FIG. 6 shows a schematic cross-sectional view of the light source 200 according to the invention. The light source 200 according to the invention comprises a plurality of light emitters 202, preferably light emitting diodes 202. The light source 200 further comprises the diffusing element 10 for diffusing the light emitted by the light emitting diodes 202 and for adapting a distribution of the light emitted by the light emitting diodes 202. In light sources 200 comprising light emitting diodes 202 for use in greenhouses 300 typically comprise naked-die light emitting diodes 202 to avoid light losses due to a cover (not shown) typically place over the light emitting diodes 202. Still, the environment inside a greenhouse 300 is relatively harsh for electronic equipment due to the relatively high humidity, and thus the light emitting diodes 202 have to be protected via a protective cover. Using the diffusing element 10 as the protective cover in the light source 200 comprising light emitting diodes 202 has the benefit that the transmission efficiency is very high, at oblique incidence typically higher compared to simple planar glass-plate. A further benefit of the use of the diffusing element 10 is that the light distribution emitted by the light emitting diodes 202 may be adapted by diffusing the transmitted light and by broadening the light distribution such that a large area is illuminated by the light source 200. Due to this arrangement the light source 200 may be arranged below the gutter 304 (see FIG. 7) of the greenhouse 300 while still the spreading of the light at high efficiency is sufficient to substantially evenly illuminate the plants in the greenhouse 300.

Of course the light source 200 may be used at different locations and in different applications and may be used to generate diffuse light at high efficiency and at a predetermined light distribution.

FIG. 7A shows a schematic cross-sectional view of the greenhouse 300 according to the invention. The greenhouse 300 shown in FIG. 7A is arranged with the roof-ridge in a north-south direction and comprises roof-panels 100 which may, for example, comprise the safety-glass panels 100, 110 shown in FIGS. 5A and 5B. Further indicated are the roof-ridge 302 and the gutter 304. Preferably any illumination systems 200 are restricted to right below the gutter 304 to limit the sunlight being blocked by the illumination systems 200. In the embodiment shown in FIG. 7A, the illumination system 200 is the light source 200 as shown in FIG. 6 in which the diffusing element is arranged to spread the light emitted by the light emitting diodes 202 generally in a east-west direction. Choosing the wave pattern 30, 32 carefully enables the light source 200 according to the invention to substantially illuminate all plants in the greenhouse 300 with substantially equal amount of diffuse light.

The roof-panels 100 comprise the diffusing element 10, 12, 14 according to the invention. Preferably, the roof-panel 100 comprises the diffusing element 10 in which the lines 50 representing protrusions 40 in the wave pattern 30, 32 are arranged in parallel lines 50 arranged in a north-south direction. Such arrangement of the wave pattern 30, 32 would distribute the sunlight impinging on the roof-panel 100 mainly in the east-west direction and thus averages out the amount of light received by the plants during the transit of the sun from east to west during the day. Thus by applying the roof-panels comprising the diffusing element 10, 12, 14 according to the invention on the greenhouse 300, light intensity variations during the day are averaged out for all plants and the light transmitted through the roof-panel 100 would be relatively diffuse. Furthermore, due to the dual wave patterns 30, 32 arranged on substantially parallel surfaces 20, 22 the diffusing element 10, 12, 14 has relatively low reflection losses and thus the impinging sunlight is efficiently converted into diffuse light having a predetermined light distribution D1, D2 (see FIGS. 3B and 4B) to evenly illuminate the plants in the greenhouse 300.

FIG. 7B schematically shows a greenhouse 400. The roof of the greenhouse 400 comprises roof ridges 302 and a gutter 304. The roof comprises roof-panels 100 comprising the diffusing element according to the invention. In the greenhouse the crops grow in rows 305 of plants. Between the rows 305 of plants there is a space 306 between two neighbouring rows 305. The roof-panels 100 comprises the diffusing element 10, 12, 14 according to the invention. The lines 308 representing the protrusions of the diffusing element 10, 12, 14 are arranged perpendicular to the rows 305 of plants. As seen in the figure, light impinging the roof panel at position 307 is spread into a distribution wherein most light is spread into the direction perpendicular to the lines 308 representing the protrusions. Thus the light is more spread into the direction of the row 305 of crops, and as such, most light is transmitted into the spaces between the rows 305 of plants and may reach the lower parts of the crops.

It should be apparent for a skilled person that the diffusing device according to the invention may also comprise coatings for achieving well known additional effects, without departing from the scope of the invention. For example, optical coatings such as anti-reflection coatings or sunlight-shielding coatings or heat insulation coatings may be easily applied on the diffusing device without altering the effect of the diffusing of the impinging light via refraction. The additional coating may require an adaption in the absolute dimensions of the wave pattern to ensure that the predetermined distribution of diffusely transmitted light is achieved. This, however, is routine optical engineering to determine the effect of such an additional coating on the diffusing device and is expected to be included in the current scope of protection.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements. In the device claim enumerating several means, several of these means may be embodied by one and the same item of hardware. The mere fact that certain measures are recited in mutually different dependent claims does not indicate that a combination of these measures cannot be used to advantage.

1. Diffusing device (10, 12, 14) for diffusing light impinging on the diffusing device (10, 12, 14), the diffusing device (10, 12, 14) comprising a first surface (20) and a second surface (22) arranged opposite the first surface (20), each one of the first surface (20) and the second surface (22) constituting a border between two transmissive media having different refractive indexes (n₁, n₂) and each one of the first surface (20) and the second surface (22) comprising a substantially continuous wave pattern (30, 32) constituted of protrusions (40) from the first surface (20) and from the second surface (22) and of indentations (42) in the first surface (20) and in the second surface (22) for diffusing the impinging light via refraction, wherein the wave pattern (30, 32) comprises a relatively smooth pattern (30, 32).

2. Diffusing device (10, 12, 14) of claim 1, wherein lines (50, 52) representing protrusions (40) in the wave pattern (30, 32) of the first surface (20) are arranged substantially parallel to further lines (50, 52) representing protrusions (40) in the wave pattern (30, 32) of the second surface (22) for generating a predetermined distribution (D1, D2) of diffusely transmitted light.

3. Diffusing device (10, 12, 14) of claim 1, wherein the wave pattern (30, 32) is configured for generating a predetermined distribution (D1, D2) of the diffusely transmitted light, the lines (50, 52) representing protrusions comprise a pattern and/or comprise a curved shape for generating the predetermined distribution (D1, D2).

4. Diffusing device (10, 12, 14) of claim 1, wherein, when there is a further surface (24, 26) present between the first surface (20) and the second surface (22), the further surface (24, 26) being a non-planar surface (24, 26).

5. Diffusing device (10, 12, 14) of claim 1, wherein a pitch (P) between two successive protrusions (40) in the wave pattern (30, 32) in a direction parallel to the surface (20, 22, 24, 26) is within a range between 0.05 millimeter and 10 millimeter.

6. Diffusing device (10, 12, 14) of claim 1, wherein an amplitude (A) between a protrusion (40) and an adjacent indentation (42) in the wave pattern (30, 32) in a direction perpendicular to the surface (20, 22, 24, 26) is within a range between 0.01 millimeter and 2 millimeter.

7. Diffusing device (10, 12, 14) of claim 1, wherein the first surface (20) is a light input surface (20) of the diffusing device (10, 12, 14), and the second surface (22) is a light output surface (22) of the diffusing device (10, 12, 14).

8. Diffusing device (10, 12, 14) of claim 1, wherein the diffusing device (10, 12, 14) comprises a substrate (60) comprising both the first surface (20) on one side of the substrate (60) and the second surface (22) on an opposite side of the substrate (60).

9. Diffusing device (10, 12, 14) of claim 8, wherein the diffusing device (12) comprises the substrate (60) and a further substrate (62) substantially identical to the substrate (60) and wherein the substrate (60) and further substrate (62) are configured for generating a translucent safety-glass panel (100, 110).

10. Safety-glass panel (100, 110) comprising the diffusing device (10, 12, 14) of claim 1.

11. Light source (200) comprising a light emitter 202) and the diffusing device (10, 12, 14) of claim 1 for diffusing the light emitted by the light emitter (202).

12. Greenhouse (300) comprising the diffusing device (10, 12, 14) according to claim 1 or comprising the safety-glass panel (100, 110).

13. Greenhouse (300) according to embodiment 13, wherein the greenhouse (300) comprises the diffusing device (10, 12, 14) or the safety-glass panel (100, 110) as roof-panel (100, 110), the lines (50, 52) representing protrusions (40) in the wave pattern (30, 32) of the first surface (20) and/or the second surface (22) are arranged, in use, in a north-south orientation.

14. Greenhouse (300) according to claim 12, wherein the lines (50, 52) representing protrusions (40) in the wave pattern (30, 32) of the first surface (20) and/or the second surface (22) are arranged, in use, substantially parallel to a roof-ridge (302) and/or a gutter (304) of the greenhouse (300).

15. Greenhouse (300) according to claim 12, wherein in the greenhouse, in use, the corps grow in substantially parallel arranged rows of plants, wherein the lines (50, 52) representing protrusions (40) in the wave pattern (30, 32) of the first surface (20) and/or the second surface (22) are arranged, in use, substantially perpendicular to rows of plants.
